(19) United States
(12) Patent Application Publication
(10) Pub. No.: US 2016/0139914 A1
(43) Pub. Date: May 19, 2016

(54) CONTEXTUAL-BASED LOCALIZATION BASED ON MANUAL TESTING

(71) Applicant: HEWLETT-PACKARD DEVELOPMENT COMPANY, L.P., Houston, TX (US)

(72) Inventors: Elad Levi, Yehud (IL); Ran Bar Zik, Yehud (IL); Liran Tal, Yehud (IL)

(21) Appl. No.: 14/897,813

(22) PCT Filed: Jun. 24, 2013
(86) PCT No.: PCT/US2013/047330

§ 371 Date: Dec. 11, 2015

(51) Int. Cl. G06F 9/44; G06F 11/36

(52) U.S. Cl. CPC G06F 8/71; G06F 11/3604

(57) ABSTRACT

Example embodiments relate to contextual-based localization based on manual testing. A system may recreate, based on code of an application and user action data, how a user interacts with the application. The user action data may indicate how the user interacts with the application while manually testing the application. The system may detect screen states in the code based on the recreation. The screen states may be associated with screens displayed to the user while the user interacts with the application. The system may create, for each of the screen states, a translation package that includes a screen shot related to the particular screen state and a reduced properties file that includes a portion of a properties file that is related to a portion of the code that is associated with the particular screen state. The properties file may include information that can be used to localize the code.

### BACKGROUND

In some scenarios, software products (e.g., software programs, applications, web applications, operating systems, etc.) may need to be provided in multiple different human languages. In some scenarios, a software product may be originally provided in a first language (e.g., a source language), and may need to be converted to at least one other language (e.g., target languages). For example, this conversion may be performed by identifying language-specific elements (e.g., displayable string elements within the user interface) of a software product and translating the string elements from the source language to the target language. Once all the language-specific elements have been translated, a language-specific version of the software product may be created for the target language. The process of converting a software product from one language to another language may be generally referred to as “localization”. In some scenarios, a software product may be designed such that it can be adapted to various languages more easily, for example, by providing placeholders that may later be substituted with language-specific elements. In this scenario, the process of adapting such a software product may also be referred to as “localization.”

### BRIEF DESCRIPTION OF THE DRAWINGS

The following detailed description references the drawings, wherein:

FIG. 1A depicts a block diagram of stages and flows of information in an example software development process that utilizes contextual-based localization based on manual testing;

FIG. 1B depicts a block diagram of a stage and flows of information in an example software development process that utilizes contextual-based localization based on manual testing;

FIG. 1C depicts a block diagram of stages and flows of information in an example software development process that utilizes contextual-based localization based on manual testing;

FIG. 2 is a block diagram of an example action listener and handler module that may be used to perform contextual-based localization based on manual testing;

FIG. 3A depicts example contents of an example translation package according to at least one embodiment of the present disclosure;

FIG. 3B depicts example contents of an example translation package according to at least one embodiment of the present disclosure;

FIG. 3C depicts example contents of an example translation package according to at least one embodiment of the present disclosure;

FIG. 4A depicts a flowchart of an example method for contextual-based localization based on manual testing;

FIG. 4B depicts a flowchart of a portion of an example method for contextual-based localization based on manual testing;

FIG. 4C depicts a flowchart of a portion an example method for contextual-based localization based on manual testing;

FIG. 5 is a block diagram of an example stage computing device for contextual-based localization based on manual testing; and

FIG. 6 is a flowchart of an example method for contextual-based localization based on manual testing.

### DETAILED DESCRIPTION

As described above, the localization process may include converting a software product (e.g., software program, application, web application, operating system, etc.) from a first language (e.g., a source language) to at least one other language (e.g., target languages), or converting a software product designed with placeholders to at least one language. In some scenarios, the localization process may be used to convert a software product to accommodate not just different languages, but also different regions (e.g., slight regional preferences), different markets (e.g., different technical requirements) or other finer adjustments.

The localization process may be very time consuming and costly. The source code of a software product may need to be prepared, for example, by identifying and extracting all language-specific elements (e.g., displayable string elements within the user interface). Code analysis tools may be used, to some extent, to identify language specific elements, but developers are often not aware of these tools or forget about them. Then, when a list of extracted language-specific elements has been assembled, the language-specific elements need to be translated. While some automatic translation programs or services may be available, such services, in many scenarios, are not sophisticated enough to provide a high-quality translation. Typically, the translation of strings is performed by a human translator who is provided with a file or table of extracted strings that require translation. The human translator will then translate the strings and return the translations to the developer, who may insert the translations into the software product. Before inserting the translations into the software product, a linguistic reviewer (e.g., a natural speaker of the target language) may review the file or table of translated strings. Additional review of the translations may be performed once the translations are inserted into the source code and the software product is run. Such reviews are labor intensive and can be extremely expensive. Additionally, such reviews may take a long time, which may result in a slow delivery of localized versions of software products.

Linguistic errors are a major problem for localized software. Linguistic errors may refer to errors in the translation of the software product that are easily detected by native users of the software product. These errors may reflect poorly on the overall quality of the software product, and may even cause the software product to malfunction (e.g., crash). Fixing linguistic errors, especially at a later stage of software product development, may require significant time and money (e.g., for translators and engineers to design and test fixes). One major cause of linguistic errors is that the human translation, and perhaps at least one round of review, are performed in isolation, e.g., without the precise context of how the strings are used in the software product. For example, in some languages, a correct translation of a word or phrase for use on a button may be different from the correct translation for use in a title or in a text box. It may be very difficult if not impossible for a translator or reviewer to provide accurate translations when the strings are lacking context. Even if the translator or reviewer is familiar with the software product, it may be hard to picture the specific location and context of a string with the software product user interface. Furthermore, the software product may not be available to the translator, and so the translator cannot interact with the software product to gain context for various strings. Even with web-based applications, the application may not be available outside of a development organization and/or authorization to the application may be prohibited to some translators.

The present disclosure describes contextual-based localization of a software product (e.g., software program, application, web application, operating system, etc.) based on manual testing. The present disclosure describes providing (e.g., to a human translator) language-specific elements that may need to be localized along with contextual information (e.g., screen shots, use statistics, etc.) of how the elements are used in the software product user interface. The present disclosure describes leveraging manual testing by a tester or user of the software product to identify multiple screen states in source code related to the software product, and automatically generating, for each of the multiple screen states, a screen shot and at least one reduced properties file that includes language specific elements displayable in such a screen shot. The present disclosure describes receiving user action data (e.g., provided as a result of the manual testing) and recreating the user's actions by emulating the environment by which the user interacted with the software product and analyzing the user action data. During such recreation, the multiple screen states may be detected and the reduced properties files and screen shots generated. The present disclosure describes automatically creating, for each of the multiple screen states, a translation package that includes the screen shot and the at least one reduced properties file associated with the particular screen state. Translation packages may be sent to a translator (e.g., a human translator) for translation and/or refinement, and may then be merged back into the source code and/or code base.

The present disclosure may provide benefits over previous localization techniques. For example, human translations may be more accurate and may take less time because a translator may be able to refer to contextual information during the translation process. Human translators may need to ask far less or no clarifying questions (e.g., questions regarding whether a particular translation is correct) to an R&D team, which may save large amounts of time (e.g., one week per round of clarifying questions). Human translators may make far fewer linguistic errors during the translation process which may result in a more polished and more functionally correct software product. Additionally, because of the streamlining of human translation in the software development process, the software development process may be much more scalable. Furthermore, the contextual information provided may be generated based on manual testing, which allows for delivering localized, high-quality software products with a significantly shortened time to market. This may be the case because manual testers may be abundant, timely, and may require little to no maintenance by the developers of the software product. Manual testers may be readily available and may exercise many of the most important features of a software product (e.g., without the need for extensive automated test engineering on the part of the software product developer). Thus, an automated testing module or program (e.g., that performs integration tests, end-to-end tests or the like) may not be required. Such automated testing modules/programs may require significant resources and maintenance to run. Additionally, such automated testing modules/programs may take significant amounts of time to run their tests and report their results. For example, such automated testing may be included in a stage of a software development lifecycle, and thus later stages may need to wait for the automated testing modules/programs. Instead, manual testing may be done in parallel with various stages of software development, and the results may be available quickly.

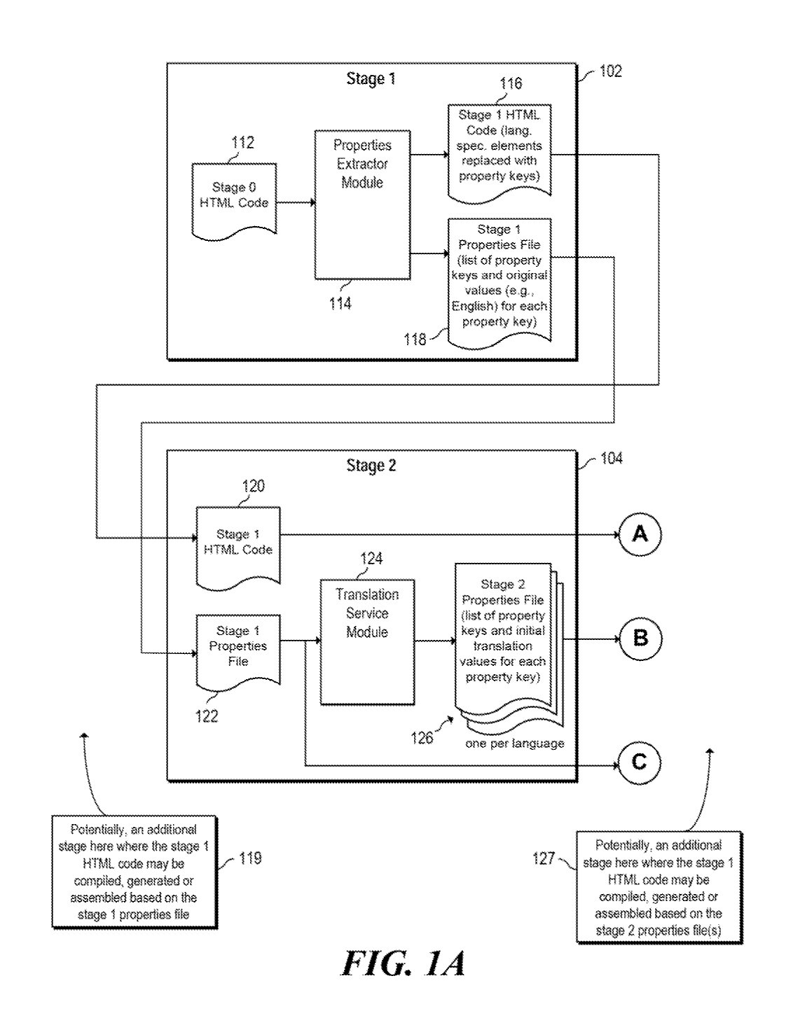

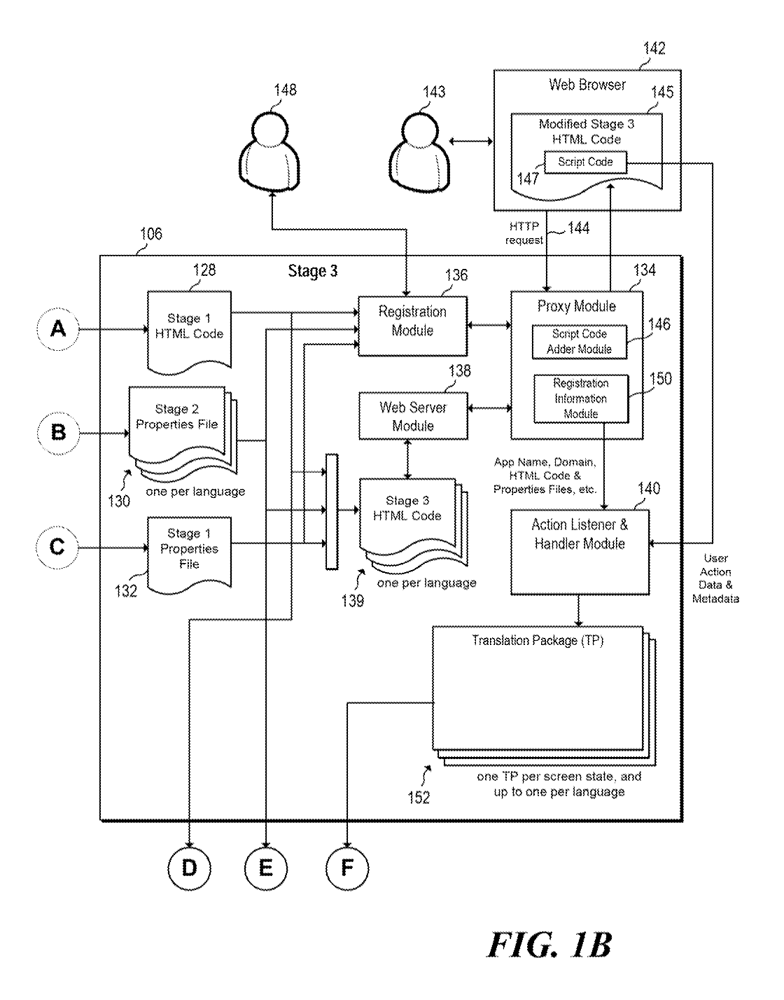

FIGS. 1A, 1B and 1C depict block diagrams of stages and flows of information in an example software development process that utilizes contextual-based localization based on manual testing. For example, stages 102, 104, 106, 108 and 110 may be included in an example software development process, according to at least one embodiment of the present disclosure. Such a software development process may include more or less stages than are shown in FIGS. 1A, 1B and 1C. For example, the software development process may include additional stages for programming the software product, compiling the software product, releasing the software product, functionally testing the software product (e.g., for bugs, performance, etc.) and the like. Any of these additional stages may be inserted between any of the stages depicted in FIGS. 1A, 1B and 1C and any of the stages depicted in FIGS. 1A, 1B and 1C may be inserted between, any stages in an existing software development process. In this respect, the stages depicted in FIGS. 1A, 1B and 1C may be integrated with any existing software development process (e.g., an Agile development process).

The term “software development process” (also referred to as “software development lifecycle”) as used herein may refer to any process for developing a software product that conforms to a structure, model or standard. Such a standard may define stages and tasks that may be required to develop, test and maintain a software product. Agile is one example standard that defines an iterative development process that relies on regular releases, regular testing and feedback. The term “stage” as used herein may be used to refer to a part of a software development process, for example, where at least one routine may be performed to progress the development of the software product. A stage may be carried out or executed on at least one computing device (e.g., referred to as a “stage computing device”). A stage computing device may execute a stage either automatically or with user input. Throughout this disclosure, it should be understood that the term “stage” may be used in a flexible manner to refer to a stage of a software development process in the abstract or to at least one stage computing device used to perform the routines of a stage.

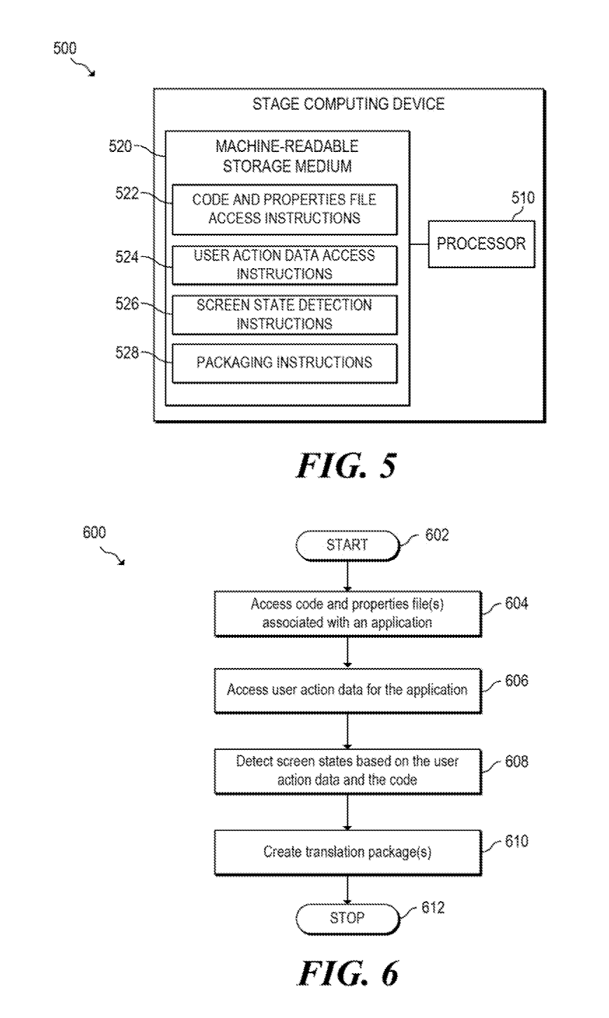

Each of stages 102, 104, 106, 108 and 110 may be performed by at least one computing device (e.g., referred to as a stage computing device), which may be, for example, any computing device capable of communicating (e.g., over a network) with at least one other computing device (e.g., another stage computing device). In some embodiments, each stage may be implemented in a different computing device. In other embodiments, two or more of the stages shown in FIGS. 1A, 1B and 1C may be implemented in the same computing device. In other embodiments, at least one stage may be implemented by more than one computing device. The term “system” may be used to refer to either a single computing device or multiple computing devices, for example, where each computing device in the system is in communication with at least one other of the multiple computing devices in the system. More details regarding example computing devices that may be used for at least one of these stages may be described below, for example, with regard to stage computing device 500 of FIG. 5.

As a starting point to discussing stages 102, 104, 106, 108 and 110, source code for a software product may be available. The term “source code” may be used herein to refer to code that may be used to run the related software product. In some situations (e.g., in the case of desktop applications), the source code and perhaps other files may be used to build an executable version of the software product. In some situations (e.g., in the case of web applications), the source code may be HTML code or some other web-based code, and the source code may be executed by a web browser, e.g., without first being compiled into an separate executable format. The term “code base” may be used to refer to all the human-written files (e.g., as opposed to tool-generated files), including the source code, that are required to run the related software product. Files in the code base other than the source code may include configuration files, properties files, resource files and the like. Referring to FIG. 1A, stage 0 HTML code 112 (and related code base) may be provided by a different stage (e.g., a stage not shown in FIG. 1A, 1B or 1C) of the software development process or as input by a user.

In various examples provided below (descriptions and related drawings), a web application may be described. For such a web application, the “source code” may be HTML code or some other web-based code or markup language, e.g., as shown in FIG. 1A with stage 0 HTML code 112. It should be understood that any descriptions and drawings provided here that refer to HTML code may be expanded to other types of web-based code or markup languages. Additionally, it should be understood that although a web application may be used in various examples below to provide a clear description, the techniques and solutions provided herein may be used for various other types of software products (e.g., desktop applications).

Stage 1 (indicated by reference number 102) may include analyzing the HTML code of a web application to identify language-specific elements and providing updated HTML code and at least one properties file. A stage computing device that implements stage 1 may receive (e.g., from an external computing device, user input or internal storage) stage 0 HTML code 112. Stage 0 HTML code 112 may refer to the HTML code as it exists in whatever state it was in before stage 1. As one example, stage 0 HTML code 112 may have been programmed and functionally tested to at least some degree. A stage 1 computing device may include a properties extractor module 114 that may analyze stage 0 HTML code 112 and provide stage 1 HTML code 116 and a stage 1 properties file 118.

Properties extractor module 114 may analyze stage 0 HTML code 112 to identify language-specific elements. The term “language-specific element” may refer to any text in the source code of a software product that may affect the way (e.g., in a language or location-specific manner) the related software product (e.g., a web application) may display to a user (e.g., via a user interface, web browser, etc.). These language-specific elements may be the items that need to be “localized” in order to convert the web application to a different language. For example, strings in the HTML code that may be displayed to a user as part of a user interface (e.g., window, button, menu, toolbar, etc.) may be language specific elements. Other examples of language-specific elements include hotkeys, coordinate sizes or any other elements that may affect the way the web application is displayed depending on the target language or region. Properties extractor module 114 may detect code in the stage 0 HTML code 112 that indicates that a text string will be displayed to a user. Properties extractor module 114 may ignore programming comments, module names and the like, for example, because the precise text of these elements may not be displayed to a user. In some scenarios, properties extractor 114 may detect placeholders that were previously inserted into the HTML code with the intention of later being substituted with language-specific elements. Properties extractor module 114 may allow a user (e.g., a member of an application build team) to search (e.g., at least partially manually) for language-specific elements or it may perform the detection automatically.

Properties extractor module 114 may replace language-specific elements or placeholders in the HTML code with new placeholders, referred to herein as “property keys.” The term “property key” may refer to a name or a text pattern that is unique to the language-specific element or placeholder that the property key replaces. A property key may be similar to a constant used in programming, where the constant name may be inserted into the source code and may take on particular designated value when the source code is compiled, assembled or generated. As explained below, later on, at least one language-specific value (e.g., translated value) may be associated with each property key. Properties extractor module 114 may step through stage 0 HTML code 112, and each time a language-specific element (e.g., a displayable string or a placeholder) is detected, properties extractor module 114 may generate a unique property key and replace the language-specific element with the property key. Properties extractor module may output stage 1 HTML code 116, which may be the same as stage 0 HTML code but with language-specific elements (or initial placeholders) replaced with property keys.

Properties extractor module 114 may generate a properties file, for example, stage 1 properties file 118. Stage 1 properties file 118 may include a list of all the property keys generated by the properties extractor module 114 while it stepped through stage 0 HTML code 112. In some embodiments, properties extractor module 114 may generate more than one properties file, for example, where each properties file includes a subset of all the property keys generated. In fact, in various embodiments, any one of the properties files discussed herein may be implemented as more than one properties file. However, for simplicity, the present disclosure may refer to various single properties files. Stage 1 properties file 118 may also include at least one value for each property key. The property key values may be used, later on, when the HTML code is compiled, assembled or generated, in which case, the values may replace the property keys in the HTML code. For the purposes of stage 1, the property key values may be initialized with the original values of the language-specific elements (e.g., from stage 0 HTML code). For example, if a string was replaced with a property key, then the value associated with that property key in the properties file may be the string. As one specific example, if an original version of the web application was provided in English, then stage 1 properties file 118 may include property key values that are in English. As another example, if an original placeholder was replaced with a property key, then the value associated with that property key in the properties file may be the original placeholder or the value may be empty.

Stage 1 may output stage 1 HTML code 116 and stage 1 properties file 118, and at least one later stage of the software development process may use these. For example, a stage 1 computing device may communicate stage 1 HTML code 116 and stage 1 properties file 118 to a stage 2 computing device. In some embodiments, a stage 1 computing device may automatically communicate stage 1 HTML code 116 and stage 1 properties file 118 to a subsequent stage (e.g., stage 2) as soon as the properties extractor 114 has generated the stage 1 HTML code 116 and/or stage 1 properties file 118. In some scenarios, the stage 1 computing device may communicate these items to at least one other stage, and then the at least one other stage may communicate these items to stage 2. In some scenarios, the stage 1 computing device may communicate these items to a stage that is later in the process than stage 2, for example, stage 3. In this respect, stage 2 may be skipped or excluded. In some scenarios, the software development process may include an additional stage (indicated by reference number 119) where the stage 1 HTML code 116 may be compiled, assembled or generated based on the stage 1 properties file 118.

Stage 2 (indicated by reference number 104) may include analyzing the stage 1 properties file, providing initial translations for at least one target language and generating at least one target language properties file (i.e., stage 2 properties file). A stage computing device that implements stage 2 may receive (e.g., from a stage 1 computing device or from internal storage) stage 1 HTML code 120 and stage 1 properties file 122. Stage 1 HTML code 120 may be the same as or a copy of stage 1 HTML code 116, and stage 1 properties file 122 may be the same as or a copy of stage 1 properties file 118. Stage 2 may pass stage 1 HTML code 120 on to later stages, for example, without modification. A stage 2 computing device may include a translation service module 124 that may analyze stage 1 properties file 122 and provide at least one stage 2 properties file 126.

Translation service module 124 may analyze stage 1 properties file 122. Translation service module 124 may step through properties file 122, and for each property key, translation service module 124 may translate the associated property key value from the source language to at least one target language. Translation service module 124 may include or access a service that is capable of performing automatic translation of words and/or phrases. For example, translation service module 124 may include or have access to a translation repository. Additionally, translation service module 124 may include or have access to a translation provider (e.g., an online translation provider accessible via an API). As described above, while some automatic translation programs or services may be available, such services, in many scenarios, are not sophisticated enough to provide a high-quality translation. Therefore, stage 2 may be thought of as providing a “first draft” of translations for the stage 1 properties file. As indicated above, in some embodiments or scenarios, stage 2 may be skipped or excluded. In these situations, a first draft translation may not be provided for the properties file (e.g., stage 1 properties file 118) before stage 3. In these situations, a localized version of the software may not be available until later stages (e.g., stage 5).

Translation service module 124 may generate one stage 2 properties file 126 for each target language (e.g., for each language for which the original web application will be provided and/or supported). In this respect, the present disclosure may support localization to multiple target languages (i.e., “supported languages”) simultaneously. Each stage 2 properties file 126 may include a list of all the property keys generated by the properties extractor module 114. Each stage 2 properties file 126 may also include a value for each property key. For the purposes of stage 2, the property key values may differ between different stage 2 properties files (e.g., of 126), depending on the target language. For example, if an original version of the web application was provided in English, then stage 1 properties file 122 may include property key values that are in English. Then, a first stage 2 properties file 126 may include property key values that are in French, and a second stage 2 properties file 126 may include property key values that are in German, and so on.

Stage 2 may output stage 1 HTML code 120 (e.g., passed to FIG. 1B via circle “A”), stage 2 properties file(s) 126 (e.g., passed to FIG. 18B via circle “B”) and stage 1 properties file 122 (e.g., passed to FIG. 1B via circle “C”), and a later stage may use these. For example, a stage 2 computing device may communicate these items to a stage 3 computing device. In some scenarios, the stage 2 computing device may communicate these items to at least one other stage, and then the at least one other stage may communicate these items to stage 3. In some scenarios, the stage 2 computing device may communicate these items to a stage that is later in the process than stage 3. In some scenarios, the software development process may include an additional stage (indicated by reference number 127) where the stage 1 HTML code 120 may be compiled, assembled or generated based on at least one of the stage 2 properties file(s) 126.

Stage 3 (indicated by reference number 106) may include receiving, for the web application, user action data (e.g., from manual testing of the web application) and then analyzing user action data along with related HTML code and properties files to generate at least one translation package (TP) for various screen states of the web application. A stage computing device that implements stage 3 may receive (e.g., from a stage 2 computing device or from internal storage) stage 1 html code 128 (e.g., passed from FIG. 1A via circle “A”), stage 2 properties file(s) 130 (e.g., passed from FIG. 1A via circle “B”) and stage 1 properties file 132 (e.g., passed from FIG. 1A via circle “C”). Stage 1 html code 128 may be the same as or a copy of stage 1 html code 120. Stage 2 properties file(s) 130 may be the same as or a copy of stage 2 properties file(s) 126, and stage 1 properties file 132 may be the same as or a copy of stage 1 properties file 122. A stage 3 computing device may include a proxy module 134, a registration module 136, a web server module 138 and an action listener and handler module 140. Each of these modules may include a series of instructions encoded on a machine-readable storage medium and executable by a processor of a stage computing device. In addition or as an alternative, each module may include one or more hardware devices including electronic circuitry for implementing the functionality described below. With respect to the modules described and shown herein, it should be understood that part or all of the executable instructions and/or electronic circuitry included within one module may, in alternate embodiments, be included in a different module shown in the figures or in a different module not shown.

A stage 3 computing device may maintain a web application, for example, in the form of HTML code (e.g., stage 3 HTML code 139). Stage 3 HTML code 139 may be received and/or generated by a stage 3 computing device in various ways. For example, a stage 3 computing device may receive stage 0 HTML code 112 from stage 1 (i.e., stage 102). Alternatively, a stage 3 computing device may generate stage 3 HTML code 139 based on at least one of stage 1 HTML code 128, stage 2 properties files 130 and stage 1 properties file 132. Stage 3 HTML code 139 may include multiple versions of the HTML code for the web application for various languages (e.g., from the various translations provided at stage 2 (i.e., stage 104)). Stage 3 HTML code 139 may be complete HTML code, for example, with property key values substituted with associated values from properties files. Or if stage 3 receives stage 0 HTML code 112, stage 3 HTML code 139 may be complete HTML code before any language-specific elements in the HTML code were replaced with property keys.

A stage 3 computing device may communicate with at least one web browser 142, for example, to allow a user 143 to manually test the web application (e.g., represented by at least one of stage 3 HTML code files 139) maintained at stage 3. User 143 may be a software tester (e.g., a web application tester), for example, a software tester employed by the organization that developed the web application. In some scenarios, user 143 may be a beta tester, e.g., a third-party tester that tests applications of various organizations for free or for a fee. User 143 may manually test the web application by using web browser 142 to send a request (e.g., HTTP request 144) to an address or URL associated with the web application and thereby retrieving HTML code (e.g., HTML code 145) associated with the web application. HTML code 145 may be similar to HTML code 139, but it may be modified as described in more detail below. Web browser 142 may then execute HTML code 145 to allow user 143 to run the web application and test its various features.

Proxy module 134 may be a proxy between the user 143/web browser 142 and a web server (e.g., web server module 138) that serves the HTML code (e.g., 139) associated with the web application. The term “proxy” may refer to a server (e.g., a computer system, application or module) that acts as an intermediary for requests from clients (e.g., user 143/web browser 142) seeking resources from and/or communication with other servers/services (e.g., web server module 138 and/or stage 3 HTML code 139). A client may connect to a proxy server, requesting some service, such as a file, communication, connection, web page, or other resource available from a different server, and the proxy server may evaluate and/or modify the request and may evaluate and/or modify the returned resource before returning the resource to the client.

In the example of FIG. 18B, the web application may be available in the form of HTML code (e.g., stage 3 HTML code 139). The application may be available to users (e.g., user 143) via an address or URL (e.g., http://XYZ.com). For example, user 143 may know the address/URL of the web application. User 143 may then use web browser 142 to navigate to the address/URL of the web application, which may cause a request (e.g., HTTP request 144) to be sent to a stage 3 computing device, and particularly to proxy module 134, which may act as an intermediary between web browser 142 and web server module 138. In order for the HTTP request to be routed to proxy module 134 instead of web server module 138, user 143 may navigate (via web browser 142) to a modified address/URL (e.g., http://ABCproxy/XYZ.com) that causes the browser to access proxy module 134 with information that, in turn, causes proxy module 134 to access the web application via web server module 138. In some scenarios, the user 143 may not need to navigate to a modified address/URL. In such situations, a stage 3 computing device may analyze all incoming HTTP requests and may detect addresses/URLs that are under testing and may route such requests to proxy module 134. Proxy module 134 may pass HTTP request 144 (e.g., in a modified format) to web server module 138. Web server module 138 may then, based on the information in the HTTP request, retrieve the HTML code (e.g., 139) of the web application and return it to the proxy module 134.

Proxy module 134 may modify the HTML code (e.g., 139) of the web application before passing the HTML code on to web browser 142. Proxy module 134 may include a script code adder module 146. Script code adder module 146 may inject or add script code (e.g., 147) into the stage 3 HTML code 139, thereby creating modified stage 3 HTML code 145 that includes script code 147. Proxy module 134 may then send modified stage 3 HTML code 145 to web browser 142 such that web browser 142 can execute it. Script code 147 may include at least one client-side script (e.g., written in JavaScript or some other scripting language). Script code adder module 146 may analyze stage 3 HTML code 139 to determine how many scripts to add and where to add scripts in the HTML code. For example, module 146 may insert a single script for the entire application. As another example, module 146 may insert a script per page and/or frame of the web application. As another example, module 146 may identify various HTML code segments that related to user input and may insert scripts that are associated with these segments. Proxy module 134 may also identify and change internal links (e.g., URL links) of the HTML code to links that will maintain the proxy intermediary if a user navigates to such links. For example, URL addresses may be modified to such that they follow a format such as http://ABCproxy/[original_address].

Script code 147 may run when web browser 142 executes modified stage 3 HTML code 145. More specifically, various scripts added to the modified stage 3 HTML code 145 (as described above) may run at various times during the execution of various pieces of modified stage 3 HTML code. For example, in the example where a script is inserted into every page of the web application, then when a particular page of the web application is executed, the associated script may execute. These various scripts (e.g., associated with various pages of the web application) may be referred to collectively as script code 147. The term “page” may be used herein in a flexible manner to refer to, depending on the context, a single visual page as displayed by a web browser (e.g., 142) and also the HTML code associated with the visual page that causes the web browser to display the visual page. A page (e.g., a visual page) may be similar to a “screen” as the term is used herein, but there are some differences. A screen may refer to visual information that is currently being displayed to a user via a display device (e.g., a monitor). A screen may include a page or a part of a page. In some situations, a page may be larger than a single screen, and thus the page may be scrollable such that different portions of the page may be visible as the page is scrolled.

Script code 147, when run, may listen for and/or detect the actions of user 143 as user 143 interacts with the web application via web browser 142. Script code 147 may enable all the input actions of user 143 to be recorded. Such input actions may be detected and recorded as information that may be referred to as user action data. For example, script code 147 may detect various action that user 143 makes via at least one input device such as a pointer, touchscreen, keyboard or the like. Script code 147 may, for example, detect all pointer events initiated by user 143, pointer events such as left click, right click, single click, double click, etc. When a user initiates theses or other pointer events, it may be said that the user activated the pointer. Script code 147 may also detect additional information related to such a pointer event, such as X and Y pointer click or point coordinates, event time, etc.

In some situations, the user action data may be generalized input data, for example, generalized input events (e.g., pointer events) and related data. As one specific example, user action data may include fields and associated data such as [URL=XYZ.com], [action=left single pointer click], [X=100,233; Y=234,42], etc. This may contrasted to user action data that is specific to a particular DOM (Document Object Model) structure used by the web browser and/or a particular web-based language (e.g., HTML 5, Flash, etc.) used by the web application and the web browser. Generalized input data may allow for compatibility with a wide variety of programming languages, web browsers, DOM structures and the like and may allow for flexible and robust recreation of the user's actions, as described in more detail below. It should be understood however, that in some situations, user action data may be is specific to a particular DOM structure, web-based language, etc.

Script code 147 may also detect various other pieces of information about the web application, for example, the name and version of the web application, an address, URL and/or domain of the web application, etc. Script code 147 may also detect various other pieces of information about the user's testing environment, for example, the type and version of web browser that the user is using, the screen resolution in which the user is viewing the web browser, and the like. These details may be used by other modules of stage 3 (e.g., module 140 and/or module 206) later to emulate the testing environment of the user. The information about the web application (e.g., name, version etc.) and the information about the user's testing environment (e.g., web browser, screen resolution, etc.) may be referred to as “metadata” of the user action data, e.g., because it provides context for the user action data.

Script code 147 may send user action data (and related metadata) for the web application to a stage 3 computing device, particularly, to action listener & handler module 140. This information may be used by the stage 3 computing device to create at least one translation package (TP) for the web application, as described in more detail below with regard to module 140.

Registration module 136 may allow a user (e.g., user 148) to register various pieces of information about the web application. As described in more detail below, such registration may allow the information being registered to be associated with user action data received from script code 147. User 148 may be an administrator, team leader, project manager or some other authorized individual. In some situations, user 148 may be part of the same organization as user 143. User 148 may register (via module 136) the web application by providing (e.g., supplying or pointing to the source of) information such as at least one of the following: the web application's name, the web application's stage 1 HTML code (e.g., 128), the web application's stage 2 properties files (e.g., 130) and the web application's stage 1 properties file (e.g., 132), the web application's stage 3 HTML code (e.g., 139), an address/URL/domain of the web application, etc. Registration module 136 may collect this registration information from user 148 and may provide this information to other modules at stage 3, for example, proxy module 134. As one example, proxy module 134 may include a registration information module 150 that may receive and store (e.g., in a physical storage device) registration information for various web applications. Registration information module 150 may provide (e.g., via a queue or other data structure) this registration information to various other modules in stage 3. For example, as shown in FIG. 1B, module 150 may provide registration information (e.g., application name, domain, HTML code, properties files, etc.) to module 140. In some examples, registration information module 150 may be located in another module, such as action listener and handler module 140, in which case, registration module 136 may provide registration information directly to module 140.

Action listener and handler module 140 may receive registration information (e.g., application name, domain, HTML code, properties files, etc.), for example, from module 150. Action listener and handler module 140 may receive user action data (and associated metadata) from web browser 142 (e.g., from script code 147 in modified stage 3 HTML code 145). Action listener and handler module 140 may analyze this received information and generate at least one translation package (TP) 152 for the web application, as described in more detail below. In some examples, module 140 may be implemented in separate computing device/server from various other modules and components of stage 3. This may allow for enhanced performance of the module. For example, module 140 may use a priority queue or some other priority mechanism to receive and handle streams of information from web browser 142 and/or proxy module 134. In some examples, module 140 may be part of proxy module 134, in which case, registration information (e.g., from module 136) may be readily available to module 140, and in which case, user action data from script code 147 may be received directly by proxy module 134.

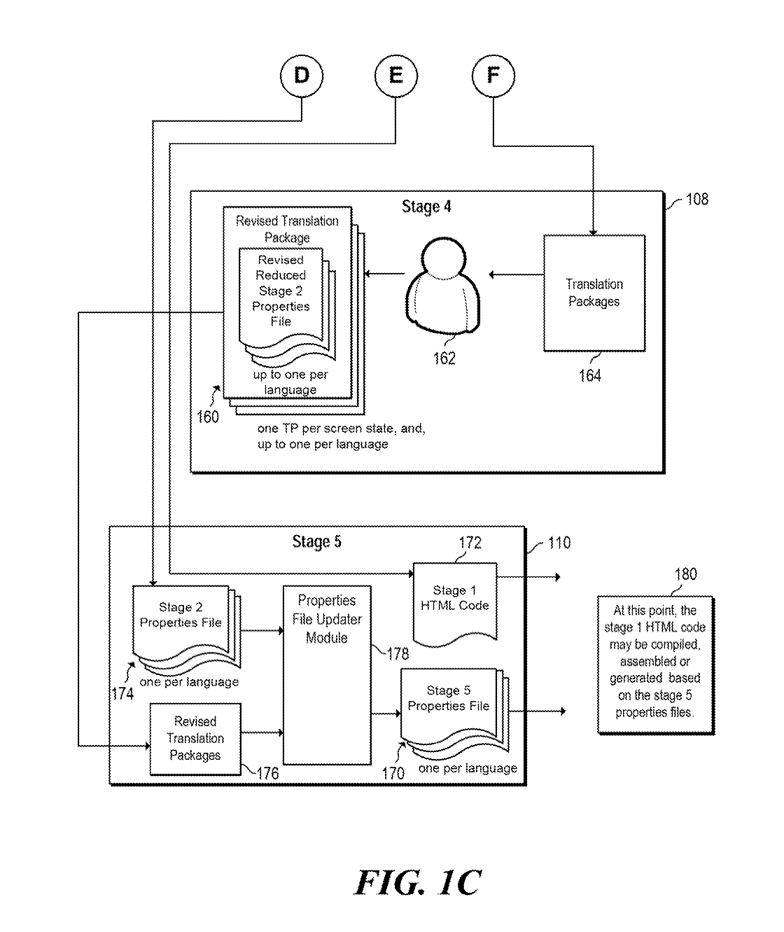

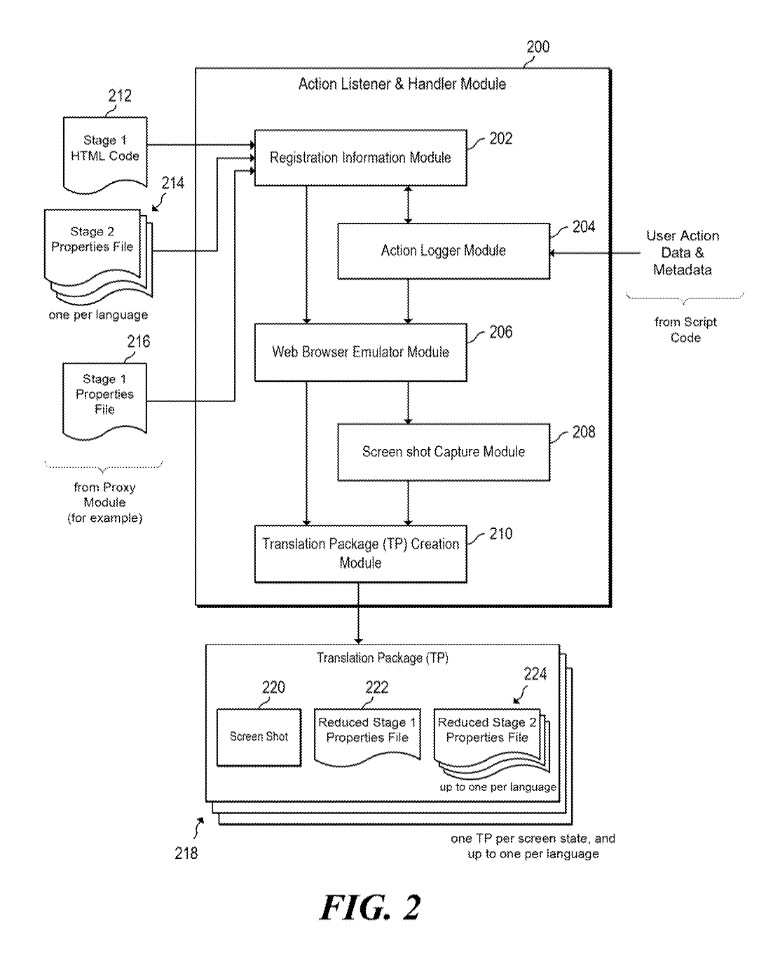

FIG. 2 is a block diagram of an action listener and handler module 200, which may be similar to module 140 of FIG. 1B, for example. Action listener and handler module 200 may include a number of modules 202, 204, 206, 208, 210. Each of these modules may include a series of instructions encoded on a machine-readable storage medium and executable by a processor of a stage computing device. In addition or as an alternative, each module may include one or more hardware devices including electronic circuitry for implementing the functionality described below. With respect to the modules described and shown herein, it should be understood that part or all of the executable instructions and/or electronic circuitry included within one module may, in alternate embodiments, be included in a different module shown in the figures or in a different module not shown.

Registration information module 202 may receive and store registration information about various web applications, for example, from proxy module 134. Registration information, as described above, may include (or point to the location of) information such as at least one of the following: the web application's name, the web application's stage 1 HTML code (e.g., 212), the web application's stage 2 properties files (e.g., 214) and the web application's stage 1 properties file (e.g., 216), the web application's stage 3 HTML code (e.g., 139), an address/URL/domain of the web application. In some situations, as described above, where proxy module 134 does not receive registration information, registration information module 202 may receive registration information directly from registration module 136, for example.

Action logger module 204 may receive user action data (and associated metadata), for example, from web browser 142 (e.g., from script code 147 in modified stage 3 HTML code 145). Action logger module 204 may store and/or log all the user action data (and related metadata) received. In this respect, action logger module 204, by working with script code 147, may record all the user actions of the tester of the web application. As described above, the metadata related to various pieces of user action data may specify the web application that the user action data is associated with. Action logger module 204 may, for each piece, packet or group of user action data, use the related metadata to communicate with module 202 to determine whether any information has been registered for the same web application. For example, module 204 may check whether an application name (and perhaps version) from the user action data metadata matches any of the application names/versions in registration module 202. As another example, module 204 may check whether a URL or domain of the user action data metadata matches any of the URLs or domains in registration module 202. If action logger module 204 detects a match in the registration information module 202, then the action listener and handler module 200 may have, for a particular web application, user action data and associated registration information (e.g., HTML code, properties files, etc.) for the user action data, and this information may be used to recreate user actions.

Web browser emulator module 206 may recreate user actions that a user performed with respect to the web application based on user action data (e.g., received by module 204) and registration information (e.g., from module 202). Web browser emulator module 206 may emulate the behavior of a web browser, for example, the same type and version of web browser used to generate the user action data (the user action data metadata may include the browser type/version). Web browser emulator module 206 may receive or access HTML code (e.g., stage 1 HTML code 212 or stage 3 HTML code 139) for the web application in order to recreate the web application. By analyzing and/or executing the HTML code and using the user action data to recreate the user's actions, module 206 may determine, for each user action, information about the state (e.g., screen state) of the application when the user action occurred.

The term “screen state” may refer to a discrete part of a user interface (UI) of a software product (e.g., a web application) that may be displayed to a user. A screen state may refer to the windows or layers that are displayed to a user, as opposed to the entirety of the screen or page that is presented to a user at any particular time. For example, if a main window were presented to a user, this may be a first screen state. Then, if a user clicked on a button and a smaller dialogue window popped up inside the main window, the smaller dialogue window may itself be a second screen state. In some embodiments, the UI information of a software product may be divided into screen states in a way such that no instances of language-based elements are duplicated between screen states. Thus, in the example from above, even while the smaller dialogue window is displaying, the first screen state would not include the same instances of language-based elements as the smaller dialogue window, and the second screen state would not include the same instances of language-based elements as the larger main window behind the dialogue window. In this respect, each instance of a language-based element that is presented to a user throughout the usage of a software product may be uniquely associated with a particular screen state.

Web browser emulator module 206 may determine, for a piece, packet or group of user action data, which screen state is associated with the data. For example, by analyzing the user action data and the HTML code, module 206 may determine which portion of the web application's HTML code is activated by the user action data (e.g., pointer click, etc.). Module 206 may identify the properties keys that are associated with this portion of the HTML code, for example, by scanning the portion of HTML code and detecting property keys. Module 206 may identify the same property keys (and associated values) in at least one properties file (e.g., at least one stage 2 properties file 214 and/or stage 1 properties file 216). For each of these properties files, module 206 may create a reduced properties file for the particular screen state and/or for the particular portion of the HTML code. Thus, for a particular screen state, module 206 may create a reduced properties file for each supported language (e.g., from state 2 properties files 214) and perhaps a reduced properties file for the original language (e.g., from stage 2 properties file 216). Each reduced properties file, for a particular language, may include only the language-specific elements (e.g., strings) that are presented to the user by the particular screen state. The language-specific elements of a reduced properties file may be extracted from the related full properties file. Web browser emulator module 206 may detect various other screen states associated with the user action data and may generate reduced properties files for these other screen states.

Web browser emulator module 206 may perform analytics analysis based on received user action data. For example, for a group of related user action data pieces (e.g., events), module 206 may detect patterns or may accumulate statistics about the user action data. User action data may be related for various reasons, for example, because it was generated by the same manual tester, because it was generated for the same web application, because it was generated for the same page and/or frame of the web application, because it was generated around the same time, etc. As one specific example, module 206 may determine where a user is focusing most of the user's input efforts, e.g., what part of the page the user is clicking the most (or least) and perhaps a related number of clicks. As one specific example, module 206 may determine which pages and/or frames of a web application are viewed the most. This analytics and/or statistics information may be sent to module 210 to be included in a TP. Such information may be useful to a translator, for example, to determine which parts of a web application are most important and/or most often used.

Screen shot capture module 208 may capture, receive, generate and/or create at least one screen shot for each piece of user action data (e.g., pointer click, etc.) or perhaps for multiple related pieces (i.e., packet or group) of user action data (e.g., multiple pointer clicks in the same screen area and/or frame). Screen shot capture module 208 may communicate with web browser emulator module 206 to receive images of the web application UI as it may look while the web application is run by a user. Web browser emulator module 206 may also indicate when a piece of user action data indicates a user input event, and this may cause screen shot capture module 208 to capture, receive, generate and/or create an appropriate screen shot (e.g., an image such as a GIF. JPG, PNG or the like). Such an image may be identical or similar to the image that a user sees when encountering the screen state while using the web application.

Translation Package (TP) creation module 210 may package (e.g., for each screen state) the associated screen shot and at least one associated reduced properties file. Translation Package (TP) creation module 210 may create a single TP for each screen state or multiple (e.g., up to one TP per supported language). Module 210 may receive (e.g., from module 208) a screen shot for each screen state. Module 210 may receive (e.g., from module 206) at least one reduced stage 2 properties file for each screen state. Module 210 may receive (e.g., from module 206) a reduced stage 1 properties file for each screen state. Module 210 may then bundle or package this information into at least one translation package (TP) 218. Translation packages 218 may be similar to translation packages 152 of FIG. 1B.

Translation Package (TP) creation module 210 may construct TP's 218 in various ways. In the specific embodiment of FIG. 2, translation packages 218 may be constructed one per screen state, where each translation package 218 includes a screen shot 220, one reduced stage 2 properties file 224 for each supported language, and perhaps a reduced stage 1 properties file 222. In other scenarios, translation packages 218 may be constructed one per screen state, and then for each screen state, one translation package per supported language. In other words, in the scenario with one TP per screen state and per supported language, the total number of translation packages may be [the number of screen states] times [the number of supported languages]. In this scenario, each translation package 218 (for a particular screen state and supported language) includes a screen shot 220, one reduced stage 2 properties file 224 for the particular supported language, and perhaps a reduced stage 1 properties file 222. In this scenario, for a particular screen shot, the translation packages (one per supported language) may include duplicate information. For example, each translation package (for a screen state) may include a copy of the associated screen shot and, perhaps, a copy of the associated reduced stage 1 properties file. In other scenarios, some translation packages (for each screen state) may include more or less reduced stage 2 properties files than other TPs. For example, one TP may support 3 languages and another TP may support 1 language.

Screen shot 220 may be an image (e.g., a GIF, JPG, PNG or the like) that shows a part of the UI that is displayed to the user in conjunction with the related screen state. Each reduced stage 2 properties file 224 may be a subset of a stage 2 properties file (e.g., 214) for the corresponding language. Each reduced stage 2 properties file 224 may include only the portions of the state 2 properties file that are associated with the related screen state. For example, a stage 2 properties file may include only property keys and values that are associated with language-specific elements that may display as a result of the related screen state. Likewise, reduced stage 1 properties file 222 may be a subset of the stage 1 properties file (e.g., 216) and may include only property keys and values from the stage 1 properties file 216 that are associated with language-specific elements that may display as a result of the related screen state.

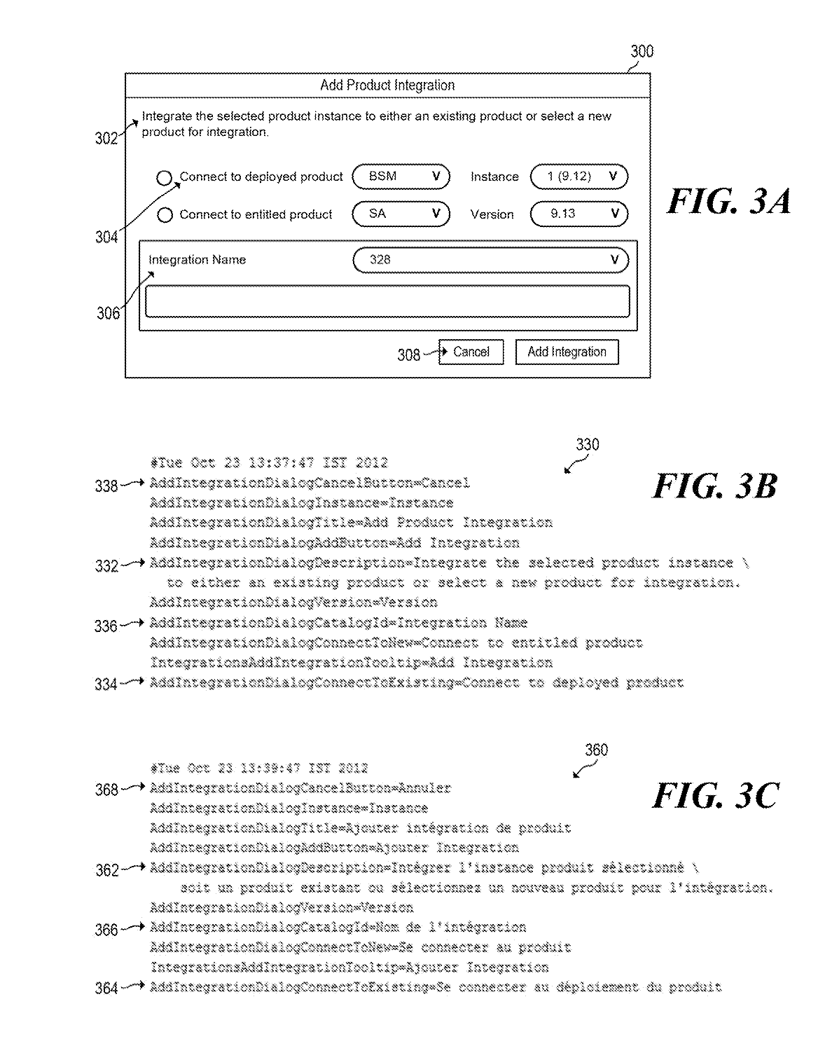

Translation package creation module 210 may then, for each screen state, package together screen shot 220, the at least one reduced stage 2 properties file 224 (e.g., one for each supported language), and perhaps a reduced stage 1 properties file 222. As explained above, in alternate embodiments, module 210 may package one TP per screen state or one TP per screen state and up to one per supported language. Translation package 218 may take the form of any file or folder that may contain multiple files (e.g., a .zip file, a .rar file, a digital folder or the like). At this point, each TP may provide various elements that need to be localized (e.g., the property keys and values from the reduced stage 1 properties file 144), a first draft of translations for the elements (e.g., the values in the reduced stage 2 properties file(s), as well as application-specific contextual information for each element (the screen shot). This information in each TP may be generally referred to as “localization information,” because it may be used by a translator to localize a software product (e.g., a web application) or a portion of a software product. FIGS. 3A to 3C depict example contents of an example translation package. FIG. 3A depicts an example screen shot 300 that may be included in an example translation package. FIG. 3B depicts at least part of an example reduced stage 1 properties file 330 (e.g., in English) that may be included in an example translation package. FIG. 3C depicts at least part of an example reduced stage 2 properties file 360 (e.g., in French) that may be included in an example translation package. As can be seen by comparing FIGS. 3A, 38 and 3C, various language-specific elements of the UI (i.e., screen shot 300) have property key (and value) counterparts in the properties files. For example, language-specific elements (e.g., displayable strings) 302, 304, 306 and 308 in FIG. 3A have counterpart property keys/values 332, 334, 336 and 338 in FIG. 3B. Likewise, for example, language-specific elements (e.g., displayable strings) 302, 304, 306 and 308 in FIG. 3A have counterpart property keys/values 362, 364, 366 and 368 in FIG. 3C. As can be seen by comparing FIGS. 38 and 3C, the property keys (e.g., “AddIntegrationDialogCancelButton”) are the same in each properties file, but the property key values are different depending on the language (e.g., “Cancel” for English and “Annuler” for French).

FIGS. 3A to 3C show an example of how a translation package may provide context for various language-specific elements that need to be translated or localized. A translation package may provide a direct link between screens that are displayable in a web application and related language-specific elements displayed in such screens. A human translator, for example, may view the English properties file (e.g., FIG. 3B) to determine the values that need to be translated. The human translator may then view the “first draft” properties file for a particular language (e.g., French in FIG. 3C) to see a potentially correct translation for the values. The human translator may then view the screen shot (e.g., FIG. 3A) to gain context for how the values are used in the web application when displayed to a user. The human translator may then confirm that the first draft translation is correct, or may modify the translation to better fit the context.

Referring again to FIG. 1B, Stage 3 may output one translation package (TP) per screen state, and perhaps up to one per language, and a later stage may use these (e.g., TP's 152 may be passed to FIG. 1C via circle “F”). At stage 3, TP's 152 may be stored in a physical storage device and may be ready for communication to a later stage. A stage 3 computing device may communicate these TP's to at least one stage 4 computing device. In some scenarios, the stage 3 computing device may communicate these TP's to at least one other stage computing device, and then the at least one other stage computing device may communicate these TP's to at least one stage 4 computing device. In some scenarios, the stage 3 computing device may communicate these TP's to at least one stage computing device that is at a later stage in the process than stage 4. In some embodiments, a stage 3 computing device may automatically communicate translation packages 152 to a subsequent stage (e.g., stage 4) as soon as a translation package module (e.g., 210) has generated the translation packages. Stage 3 may also output stage 1 HTML code 128 (e.g., passed to FIG. 1C via circle “D”) and stage 2 properties file(s) 130 (e.g., passed to FIG. 1C via circle “E”), and a later stage may use these. For example, a stage 3 computing device may communicate these items to a stage 5 computing device. In some scenarios, the stage 3 computing device may communicate these items to at least one other stage, and then the at least one other stage may communicate these items to stage 5. In some scenarios, the stage 3 computing device may communicate these items to a stage that is later in the process than stage 5.

Stage 4 (indicated by reference number 108) may include analyzing the translation packages to generate revised translation packages that may include more accurate translations than the “first draft” translations that may be included in translation packages from earlier stages. Stage 4 may include analysis and input by at least one human reviewer or translator (e.g., 162). Stage 4 may be implemented by more than one computing device, for example, up to one computing device per supported language. In this scenario, each computing device may receive input from a human translator of a different language. Stage 4 may receive (e.g., from a stage 3 computing device) translation packages 164 (e.g., passed from FIG. 1B via circle “F”). Translation packages 164 may be the same as or a copy of at least some of translation packages 152 of FIG. 1B. As explained above, each translation package may include one reduced stage 2 properties file (e.g., for a particular screen state and a particular language), or may include more than one reduced stage 2 properties file. For example, if a human translator of a particular stage 4 computing device can only translate to one target language, the translation packages may only include stage 2 properties files for that language. As another example, if a human translator can translate to all the supported languages, the translation packages may include stage 2 properties files for all the supported languages. As explained above, translation packages may be automatically sent by a previous stage (e.g., stage 3). As a result, a human reviewer may receive an email notification or some other notification (e.g., generated and/or communicated by an earlier stage) that a translation package is ready to review or translate.

Human translator 162 may review translation packages 164. As explained above, the review and translation process for the human reviewer may be much easier because the translation packages include screen shots (to add contextual information) associated with reduced properties files, as well as first drafts of translations. Because the translation process has been made much easier, stage 4 may be implemented, for example, by online freelance translators (e.g., Amazon's Mechanical Turk or the like). Additionally, the translation times may be reduced which means later stages (e.g., stage 5) may begin sooner. Human translator 162 may create revised translation packages 160, for example, one per screen state (e.g., for the same screen states as in translation packages 164).

Each revised translation package 160 may include at least one revised reduced stage 2 properties files. For example, if the translation packages 164 each included multiple stage 2 properties files for different languages, then each revised translation package 160 may include multiple revised reduced stage 2 properties files. On the other hand, if the translation packages 164 each included a single stage 2 properties file (e.g., for a single target language), then each revised translation package 160 may include a single revised reduced stage 2 properties files. Each revised reduced stage 2 properties file 160 may be the same as a corresponding reduced stage 2 properties file in translation packages 164, but human translator 162 may have changed or revised some of the property key values, for example, to provide a more accurate translation. Once the revised translation packages 160 are created, they may be communicated or submitted to a later stage (e.g., stage 5) to be committed to the source code base. For example, a stage 4 computing device may include an interface by which human translator may indicate and submit revised translation packages, and then the revised translation packages may be automatically communicated to later stages (e.g., stage 5).

Thus, stage 4 may output one revised translation package 160 per screen state, and perhaps, up to one per language, and a later stage may use these. For example, a stage 4 computing device may communicate these items to a stage 5 computing device. In some scenarios, the stage 4 computing device may communicate these items to at least one other stage, and then the at least one other stage may communicate these items to stage 5. In some scenarios, the stage 4 computing device may communicate these items to a stage that is later in the process than stage 5. In some scenarios, where multiple computing devices (e.g., for multiple human translators of different languages) are used for stage 4, each stage 4 computing device may output its associated translation packages, for example, one per screen state, for the language(s) that the computing device can handle.

Stage 5 (indicated by reference number 110) may include updating the code base based on the revised translation packages. A stage computing device that implements stage 5 may receive (e.g., from a stage 3 computing device) stage 1 HTML code 172 (e.g., passed from FIG. 1B via circle “E”) and stage 2 properties files 174 (e.g., passed from FIG. 1B via circle “D”). Stage 1 HTML code 172 may be the same as or a copy of stage 1 HTML code 128, and stage 2 properties files 174 may be the same as or a copy of stage 2 properties files 130. The stage 5 computing device may receive (e.g., from at least one stage 4 computing device) revised translation packages 176. Revised translation packages 176 may include the same or a copy of revised translation packages 160, and perhaps revised translation packages from other stage 4 computing device (e.g., that handle other languages). A stage 5 computing device may include a listener module (not shown) that detects when revised translation packages are submitted (e.g., by an interface in stage 4, by a human translator). The routines of stage 5 may begin automatically when revised translation packages are received. A stage 5 computing device may include a properties file updater module 178 which may generate at least one stage 5 properties file 170. This module may include a series of instructions encoded on a machine-readable storage medium and executable by a processor of a stage computing device. In addition or as an alternative, this module may include one or more hardware devices including electronic circuitry for implementing the functionality described below.

Properties file updater module 178 may analyze the stage 2 properties files 174 and the revised translation packages 176, and may update the values in the stage 2 properties files with any corresponding values in the revised translation packages 176. As one example method of updating, properties file updater module 178 may read a first stage 2 properties file 174 (e.g., for a first language). For each property key and value in the file, properties file updater module 178 may search the revised translation package 176 (e.g., only searching in revised reduced stage 2 properties files of the same language) for the same property key. If the same property key exists, properties file updater module 178 may replace (e.g., in memory) the property key value in the stage 2 properties file with the value from the revised reduced stage 2 properties file. Once all the property keys in the first stage 2 properties files have been searched for (and perhaps values replaced), properties file updater module 178 may generate a stage 5 properties file 170 for that language, for example, by writing the stage 2 properties file with replaced values to a new file. Properties file updater module 178 may repeat the above process for the rest of the stage 2 properties files (for other supported language), generating corresponding stage 5 properties files 170 for the other supported languages.

At this point, stage 5 may include an updated code base for the software product (e.g., web application). The code base may include stage 1 HTML code 172 and stage 5 properties files (e.g., one per supported language). At this point, in this stage or a different stage (e.g., indicated by reference number 180), the HTML code may be compiled, assembled or generated based on the stage 5 properties file. The HTML code may be compiled, assembled or generated for every supported language. Thus, for example, multiple instances of the software product may be generated, one for each supported language. Then, later, when a user is installing the software product, an installer may choose which instance of the application to install or provide based on various factors, for example, the user's country, region, locale or the like.

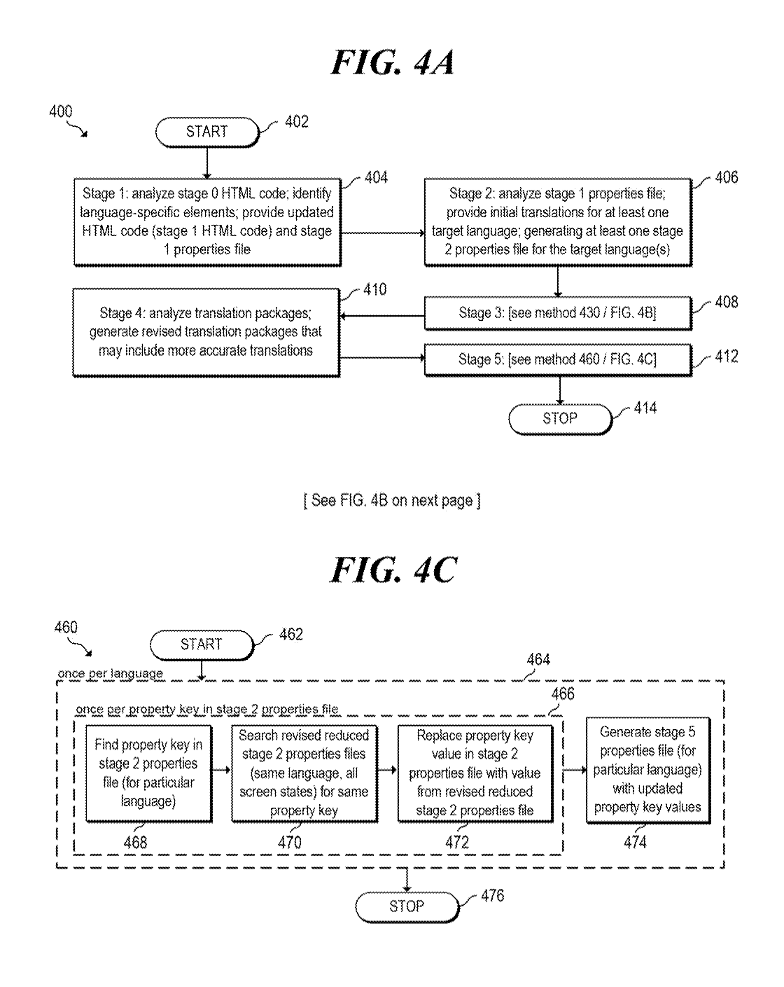

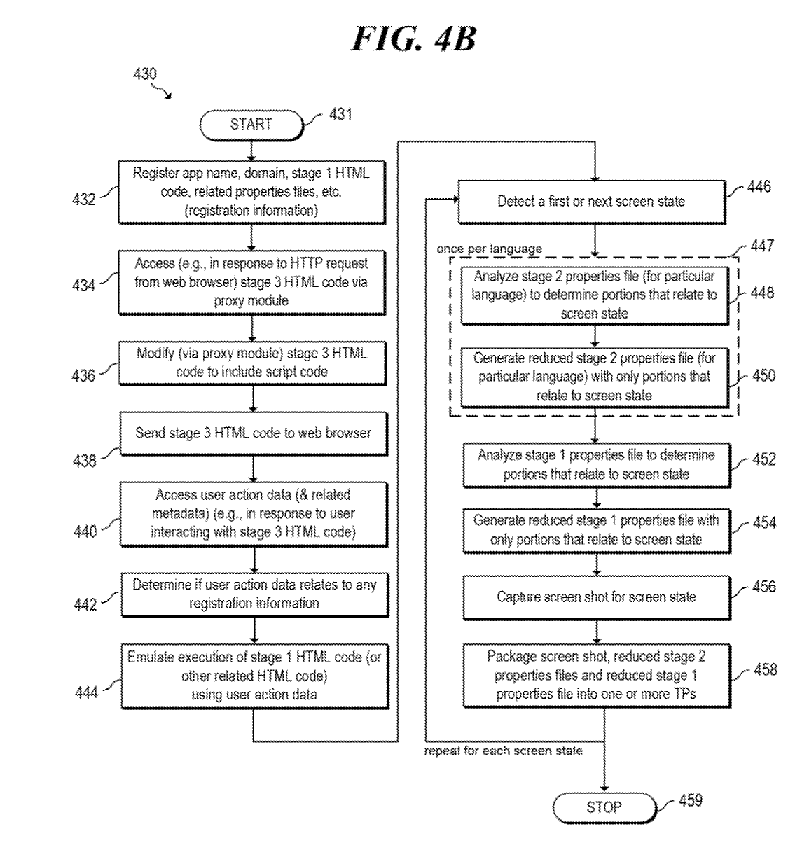

FIGS. 4A to 4C depict a flowchart of an example method 400 for contextual-based localization based on manual testing. Method 400 may include multiple sub-methods, which, for simplicity, may simply be referred to as methods. For example, methods 430 (FIG. 4B) and 460 (FIG. 4C) may be part of method 400. Methods 400, 430, 460 may be described below as being executed or performed by a system, which may refer to either a single computing device (e.g., a stage computing device) or multiple computing devices, where these one or more computing devices may execute or perform at least one stage (e.g., stages 102, 104, 106, 108, 110) of a software development process. Methods 400, 430, 460 may be implemented in the form of executable instructions stored on at least one machine-readable storage medium, such as storage medium 520, and/or in the form of electronic circuitry. In alternate embodiments of the present disclosure, one or more steps of methods 400, 430, 460 may be executed substantially concurrently or in a different order than shown in FIGS. 4A to 4C. In alternate embodiments of the present disclosure, methods 400, 430, 460 may include more or less steps than are shown in FIGS. 4A to 4C. In some embodiments, one or more of the steps of methods 400, 430, 460 may, at certain times, be ongoing and/or may repeat.

FIG. 4A is a high-level flowchart of an example method 400 for contextual-based localization based on manual testing. Method 400 may start at step 402 and continue to step 404, where a system (e.g., as part of stage 102) may analyze (e.g., via module 114) stage 0 HTML code (e.g., 112) to identify language-specific elements and provide updated HTML code (e.g., stage 1 HTML code 116) and a stage 1 properties file (e.g., 118). At step 406, the system (e.g., as part of stage 104) may analyze (e.g., via module 124) the stage 1 properties file (e.g., 122) to provide initial translations for at least one target language and generate at least one stage 2 properties file (e.g., 126) for the target language(s). At step 408, the system (e.g., as part of stage 106) may execute or perform various routines as specified in more detail in method 430 (FIG. 4B). At step 410, the system (e.g., as part of stage 108) may analyze (e.g., via human translator 162) translation packages (e.g., generated at step 408) to generate revised translation packages (e.g., 160) that may include more accurate translations. At step 412, the system (e.g., as part of stage 110) may execute or perform various routines as specified in more detail in method 460 (FIG. 4C). Method 400 may eventually continue to step 414, where method 400 may stop.

FIG. 4B is a flowchart of an example method 430 for contextual-based localization based on manual testing. Method 430 may be part of method 400, for example, substituted for step 408. Method 430 may be may be executed or performed as part of stage 106 in FIG. 1B, for example. Method 430 may start at step 431 and continue to step 432, where a system may allow (e.g., via module 136) for registration of at least one web application name (e.g., by allowing a user to provide an application name, stage 1 HTML code, related properties files, etc., generally referred to as registration information). At step 434, the system may access (e.g., in response to an HTTP request from a web browser) stage 3 HTML code (e.g., 139) via a proxy module (e.g., 134), as described in more detail above. At step 436, the system may modify (e.g., via proxy module) the stage 3 HTML code to include script code (e.g., 147). At step 438, the system may send the stage 3 HTML code to the web browser. At step 440, the system may access (e.g., receive) user action data (and related metadata) from the web browser (e.g., via script code 147), for example, in response to a user interacting with the stage 3 HTML code via the web browser. At step 442, the system may determine (e.g., via module 204 of FIG. 2) whether the user action data relates to any of the registration information, as described in more detail above.

At step 444, the system may emulate (e.g., via module 206) the execution of HTML code (e.g., stage 1 HTML code 128 or stage 3 HTML code 139) related to the web application using the user action data to recreate the user's actions. At step 446, the system may detect (e.g., via module 206) a first or next screen state associated with the web application and the user action data. At this point, the steps included in box 447 (e.g., steps 448 and 450) may be executed once for each supported language. At step 448, the system may analyze (e.g., via module 206) a stage 2 properties file (e.g., 130 or 214) for a particular language to determine portions that relate to the screen state. At step 450, the system may generate (e.g., via module 206) a reduced stage 2 properties file (e.g., 224) for the particular language, including only portions of the stage 2 properties file that relate to the screen state. At step 452, the system may analyze (e.g., via module 206) the stage 1 properties file (e.g., 132 or 216) to determine portions that relate to the screen state. At step 454, the system may generate (e.g., via module 206) a reduced stage 1 properties file (e.g., 222) that includes only portions of the stage 1 properties file that relate to screen state. At step 456, the system may capture (e.g., via module 208) a screen shot for the screen state. At step 458, the system may package (e.g., via module 210) the screen shot, the reduced stage 2 properties files and the reduced stage 1 properties file into one or more translation packages (e.g., 152 or 218), as described in more detail above. Method 430 may then return to step 446 and repeat the method for each screen state detected. Method 430 may eventually continue to step 459, where method 430 may stop.

FIG. 4C is a flowchart of an example method 460 for contextual-based localization based on manual testing. Method 460 may be part of method 400, for example, substituted for step 412. Method 460 may be may be executed or performed as part of stage 110 in FIG. 1C, for example. Method 460 may start at step 462 and continue to the steps in box 464. The steps included in box 464 (e.g., steps in box 466 and step 474) may be executed once for each supported language. The method may continue to the steps included in box 466, which may be executed once for each property key included in the stage 2 properties file (e.g., 174) for the particular language. At step 468, a system may find (e.g., module 178) the first or next property key in the stage 2 properties file. At step 470, the system may search the revised reduced stage 2 properties files (e.g., in at least one revised translation package 176) for the particular language (and for all screen states) to find the same property key. At step 472, the system may replace (e.g., via module 178) the property key value in the stage 2 properties file with the value from the revised reduced stage 2 properties file in which the same property key was found. At step 474, the system may generate a stage 5 properties file (for the particular language) using the update property key values determined in the steps of box 466. Method 460 may eventually continue to step 476, where method 460 may stop.

FIG. 5 is a block diagram of an example stage computing device 500 for contextual-based localization based on manual testing. Stage computing device 500 may be any computing device capable of communicating (e.g., over a network) with at least one other computing device. More details regarding stages that may utilize at least one stage computing device similar to stage computing device 500 may be described above, for example, with respect to FIGS. 1A, 1B, 1C and 2. In the embodiment of FIG. 5, stage computing device 500 includes a processor 510 and a machine-readable storage medium 520.

Processor 510 may be one or more central processing units (CPUs), microprocessors, and/or other hardware devices suitable for retrieval and execution of instructions stored in machine-readable storage medium 520. In the particular embodiment shown in FIG. 5, processor 510 may fetch, decode, and execute instructions 522, 524, 526, 528 to perform contextual-based localization based on manual testing. As an alternative or in addition to retrieving and executing instructions, processor 510 may include one or more electronic circuits comprising a number of electronic components for performing the functionality of one or more of instructions in machine-readable storage medium 520 (e.g., instructions 522, 524, 526, 528). With respect to the executable instruction representations (e.g., boxes) described and shown herein, it should be understood that part or all of the executable instructions and/or electronic circuits included within one box may, in alternate embodiments, be included in a different box shown in the figures or in a different box not shown.

Machine-readable storage medium 520 may be any electronic, magnetic, optical, or other physical storage device that stores executable instructions. Thus, machine-readable storage medium 520 may be, for example, Random Access Memory (RAM), an Electrically-Erasable Programmable Read-Only Memory (EEPROM), a storage drive, an optical disc, and the like. Machine-readable storage medium 520 may be disposed within stage computing device 500, as shown in FIG. 5. In this situation, the executable instructions may be “installed” on the device 500. Alternatively, machine-readable storage medium 520 may be a portable (e.g., external) storage medium, for example, that allows stage computing device 500 to remotely execute the instructions or download the instructions from the storage medium. In this situation, the executable instructions may be part of an “installation package”. As described herein, machine-readable storage medium 520 may be encoded with executable instructions for contextual-based localization based on manual testing. Although the particular embodiment of FIG. 5 includes instructions that may be included in a particular sage (e.g., stage 106) of a software development process, computing device 500 may instead or in addition include instructions related to other stages of such a software development process.

Code and properties file access instructions 522 may access (e.g., receive), for an application, code and a properties file, wherein the properties file includes information that can be used to localize the code, as described in more detail above. User action data access instructions 524 may access (e.g., receive), for the application, user action data that indicates how a user interacts with the application while manually testing the application, as described in more detail above. Screen state detection instructions 526 may recreate, based on the user action data and the code, how the user interacts with the application. Based on the recreation, these instructions may detect screen states in the code that are associated with screens displayed to the user while the user interacts with the application, as described in more detail above. Packaging instructions 528 may create, for each of the screen states, a translation package that includes a screen shot related to the particular screen state and a reduced properties file that includes a portion of the properties file that is related to a portion of the code that is associated with the particular screen state, as described in more detail above.

FIG. 6 is a flowchart of an example method 600 for contextual-based localization based on manual testing. Methods 600 may be described below as being executed or performed by a system, which may refer to either a single computing device (e.g., a stage computing device) or multiple computing devices, where these one or more computing devices may execute or perform at least one stage (e.g., stages 102, 104, 106, 108, 110) of a software development process. Method 600 may be implemented in the form of executable instructions stored on a machine-readable storage medium, such as storage medium 520, and/or in the form of electronic circuitry. In alternate embodiments of the present disclosure, one or more steps of method 600 may be executed substantially concurrently or in a different order than shown in FIG. 6. In alternate embodiments of the present disclosure, method 600 may include more or less steps than are shown in FIG. 6. In some embodiments, one or more of the steps of method 600 may, at certain times, be ongoing and/or may repeat.

Method 600 may start at step 602 and continue to step 604, where a system may access (e.g., receive), for an application, code and a properties file, wherein the properties file includes information that can be used to localize the code. At step 606, the system may access (e.g., receive), for the application, user action data that indicates how a user interacts with the application while manually testing the application. At step 608, the system may recreate, based on the user action data and the code, how the user interacts with the application. Based on the recreation, the system may detect screen states in the code that are associated with screens displayed to the user while the user interacts with the application. At step 610, the system may create, for each of the screen states, a translation package that includes a screen shot related to the particular screen state and a reduced properties file that includes a portion of the properties file that is related to a portion of the code that is associated with the particular screen state. Method 600 may eventually continue to step 612, where method 600 may stop.

1. A system for contextual-based localization based on manual testing, the system comprising:
at least one processor to:
access, for an application, first code, second code and a properties file, wherein the second code is similar to the first code but with multiple language-specific elements replaced with property keys, and wherein the properties file includes associated language-specific values for the property keys;
access, for the application, user action data that indicates how a user interacts with the application while manually testing the application;
based on the user action data and the first code or second code, determine screens that are displayed to the user while the user interacts with the application, and detect screen states in the first code or second code that are associated with the screens displayed to the user and the user action data; and
create, for each of the screen states, a translation package that includes a screen shot related to the particular screen state and a reduced properties file that includes a portion of the properties file that is related to a portion of the first code or second code that is associated with the particular screen state.

2. The system of claim 1, wherein the user interacts with the application via a web browser that executes a modified version of the first code, and wherein the at least one processor is further to:
create the modified version of the first code by inserting script code that detects how the user interacts with the application and outputs the user action data; and
send the modified version of the first code to the web browser for execution.

3. The system of claim 2, wherein least one processor is further to run a proxy module that receives a request from the web browser to access the application and in response, returns the modified version of the first code to the web browser.

4. The system of claim 1, wherein the user action data includes an indication of a page of the application that was accessed by the user and associated pointer data that indicates how the user activated a pointer of the system to interact with the page.

5. The system of claim 4, wherein the user action data includes click or point coordinates that indicate a position on a screen where the pointer was located when the user activated the pointer.

6. The system of claim 1, wherein the user interacts with the application via a web browser, and wherein to determine screens that are displayed to the user while the user interacts with the application, the at least one processor is further to execute a web browser emulator that emulates the web browser.

7. The system of claim 1, wherein the at least one processor is further to send, upon creation, the translation packages respectively associated with the screen states to a computing device that performs translations, wherein the computing device revises the language-specific values in the reduced properties files to create, for each of the screen states, a revised translation package.

8. A method for contextual-based localization based on manual testing, the method comprising:
accessing, for an application, code and a properties file, wherein the properties file includes information that can be used to localize the code;
accessing, for the application, user action data that indicates how a user interacts with the application while manually testing the application;
based on the user action data and the code, recreating how the user interacts with the application, and based on the recreation, detecting screen states in the code that are associated with screens displayed to the user while the user interacts with the application; and
creating, for each of the screen states, a translation package that includes a screen shot related to the particular screen state and a reduced properties file that includes a portion of the properties file that is related to a portion of the code that is associated with the particular screen state.

9. The method of claim 8, wherein the recreation is performed by a browser emulator that determines the screens that are displayed to the user while the user interacts with the application, wherein the screens are used to create the screen shots of the translation packages.

10. The method of claim 8, further comprising:
allowing a user to register the code and the properties file; and
determining that the user action data is associated with the code and the properties file based on the registration.

11. The method of claim 8, wherein the user interacts with the application via a web browser that executes a modified version of the code, the method further comprising:
running a proxy that receives a request from the web browser to access the application;
creating the modified version of the code by inserting script code that detects how the user interacts with the application and outputs the user action data; and
sending the modified version of the code to the web browser for execution.

12. The method of claim 8, wherein the user action data includes generalized input data that indicates how the user interacted with a page of the application via an input device, wherein the generalized input data is not specific to a document object model, programming language or web browser.

13. A machine-readable storage medium encoded with instructions executable by at least one processor of at least one stage computing device for contextual-based localization based on manual testing, the machine-readable storage medium comprising:
instructions to recreate, based on code of an application and user action data, how a user interacts with the application, wherein the user action data indicates how the user interacts with the application while manually testing the application;
instructions to detect screen states in the code based on the recreation, wherein the screen states are associated with screens displayed to the user while the user interacts with the application; and
instructions to create, for each of the screen states, a translation package that includes a screen shot related to the particular screen state and a reduced properties file that includes a portion of a properties file that is related to a portion of the code that is associated with the particular screen state, wherein the properties file includes information that can be used to localize the code.

14. The machine-readable storage medium of claim 13, further comprising instructions to send, upon creation, the translation packages respectively associated with the screen states to a computing device that performs translations, wherein the computing device revises the reduced properties files of the translation packages to provide more accurate information that can be used to more accurately localize the code

15. The machine-readable storage medium of claim 14, further comprising:
instructions to receive from the computing device the revised reduced properties files; and
instructions to create a modified version of the code based on the revised reduced properties files.
